(19) United States
(12) Patent Application Publication
(10) Pub. No.: US 2007/0130455 A1
(43) Pub. Date: Jun. 7, 2007

(54) Series encryption in a quantum cryptographic system

(76) Inventor: Brig Barnum Elliott, Arlington, MA (US)

Correspondence Address: HARRITY SNYDER, L.L.P., Suite 600, 11350 Random Hills Road, Fairfax, VA, 22030, US

(21) Appl. No.: 11/294,413

(22) Filed: Dec. 6, 2005

(51) Int. Cl. H04L 9/00

(52) U.S. Cl. 713/150

(57) ABSTRACT

A system obtains first encryption key material using quantum cryptographic mechanisms and obtains second encryption key material using non-quantum cryptographic mechanisms. The system encrypts data using the first encryption key material to produce first encrypted data and encrypts the first encrypted data using the second encryption key material to produce second encrypted data.

### GOVERNMENT CONTRACT

The U.S. Government has a paid-up license in this invention and the right in limited circumstances to require the patent owner to license others on reasonable terms as provided for by the terms of Contract No. F30602-01-C-0170, awarded by the Defense Advanced Research Project Agency (DARPA).

### FIELD OF THE INVENTION

The present invention relates generally to cryptographic systems and, more particularly, to cryptographic systems employing quantum cryptography.

### BACKGROUND OF THE INVENTION

Within the field of cryptography, it is well recognized that the strength of any cryptographic system depends on, among other things, the key distribution technique employed. For conventional encryption to be effective, such as a symmetric key system, two communicating parties must share the same key and that key must be protected from access by others. The key must, therefore, be distributed to each of the parties. FIG. 1 shows one form of a conventional key distribution process. As shown in FIG. 1, for a party, Bob, to decrypt ciphertext encrypted by a party, Alice or a third party must share a copy of the key with Bob. This distribution process can be implemented in a number of conventional ways including the following: 1) Alice can select a key and physically deliver the key to Bob; 2) a third party can select a key and physically deliver the key to Bob; 3) if Alice and Bob both have an encrypted connection to a third party, the third party can deliver a key on the encrypted links to Alice and Bob; 4) if Alice and Bob have previously used an old key, Alice can transmit a new key to Bob by encrypting the new key with the old; and 5) Alice and Bob may agree on a shared key via a one-way mathematical algorithm, such as Diffie-Helman key agreement. All of these distribution methods are vulnerable to interception of the distributed key by an eavesdropper Eve, or by Eve “cracking” the supposedly one-way algorithm. Eve can eavesdrop and intercept or copy a distributed key and then subsequently decrypt any intercepted ciphertext that is sent between Bob and Alice. In conventional cryptographic systems, this eavesdropping may go undetected, with the result being that any ciphertext sent between Bob and Alice is compromised.

To combat these inherent deficiencies in the key distribution process, researchers have developed a key distribution technique called quantum cryptography. Quantum cryptography employs quantum systems and applicable fundamental principles of physics to ensure the security of distributed keys. Heisenberg's uncertainty principle mandates that any attempt to observe the state of a quantum system will necessarily induce a change in the state of the quantum system. Thus, when very low levels of matter or energy, such as individual photons, are used to distribute keys, the techniques of quantum cryptography permit the key distributor and receiver to determine whether any eavesdropping has occurred during the key distribution. Quantum cryptography, therefore, prevents an eavesdropper, like Eve, from copying or intercepting a key that has been distributed from Alice to Bob without a significant probability of Bob's or Alice's discovery of the eavesdropping.

A well known quantum key distribution scheme involves a quantum channel, through which Alice and Bob send keys using polarized or phase encoded photons, and a public channel, through which Alice and Bob send ordinary messages. Since these polarized or phase encoded photons are employed for quantum key distribution (QKD), they are often termed QKD photons. The quantum channel is a transmission medium that isolates the QKD photons from interaction with the environment. The public channel may include a channel on any type of communication network such as a Public Switched Telephone Network, the Internet, or a wireless network. An eavesdropper, Eve, may attempt to measure the photons on the quantum channel. Such eavesdropping, however, will induce a measurable disturbance in the photons in accordance with the Heisenberg uncertainty principle. Alice and Bob use the public channel to discuss and compare the photons sent through the quantum channel. If, through their discussion and comparison, they determine that there is no evidence of eavesdropping, then the key material distributed via the quantum channel can be considered completely secret.

FIG. 2 illustrates a well-known scheme 200 for quantum key distribution in which the polarization of each photon is used for encoding cryptographic values. To begin the quantum key distribution process, Alice generates random bit values and bases 205 and then encodes the bits as polarization states (e.g., 0°, 45°, 90°, 135°) in sequences of photons sent via the quantum channel 210 (see row 1 of FIG. 3). Alice does not tell anyone the polarization of the photons she has transmitted. Bob receives the photons and measures their polarization along either a rectilinear or diagonal basis with randomly selected and substantially equal probability. Bob records his chosen basis (see row 2 of FIG. 3) and his measurement results (see row 3 of FIG. 3). Bob and Alice discuss 215, via the public channel 220, which basis he has chosen to measure each photon. Bob, however, does not inform Alice of the result of his measurements. Alice tells Bob, via the public channel, whether he has made the measurement along the correct basis (see row 4 of FIG. 3). In a process called “sifting” 225, both Alice and Bob then discard all cases in which Bob has made the measurement along the wrong basis and keep only the ones in which Bob has made the measurement along the correct basis (see row 5 of FIG. 3).

Alice and Bob then estimate 230 whether Eve has eavesdropped upon the key distribution. To do this, Alice and Bob must agree upon a maximum tolerable error rate. Errors can occur due to the intrinsic noise of the quantum channel and eavesdropping attack by a third party. Alice and Bob choose randomly a subset of photons m from the sequence of photons that have been transmitted and measured on the same basis. For each of the m photons, Bob announces publicly his measurement result. Alice informs Bob whether his result is the same as what she had originally sent. They both then compute the error rate of the m photons and, since the measurement results of the m photons have been discussed publicly, the polarization data of the m photons are discarded. If the computed error rate is higher than the agreed upon tolerable error rate (typically no more than about 15%), Alice and Bob infer that substantial eavesdropping has occurred. They then discard the current polarization data and start over with a new sequence of photons. If the error rate is acceptably small, A lice and Bob adopt the remaining polarizations, or some algebraic combination of their values, as secret bits of a shared secret key 235, interpreting horizontal or 45 degree polarized photons as binary 0's and vertical or 135 degree photons as binary 1's (see row 6 of FIG. 3). Conventional error detection and correction processes, such as parity checking or convolutional encoding, may further be performed on the secret bits to correct any bit errors due to the intrinsic noise of the quantum channel.

Alice and Bob may also implement an additional privacy amplification process 240 that reduces the key to a small set of derived bits to reduce Eve's knowledge of the key. If, subsequent to discussion 215 and sifting 225, Alice and Bob adopt n bits as secret bits, the n bits can be compressed using, for example, a hash function. Alice and Bob agree upon a publicly chosen hash function ƒ and take K=ƒ(n bits) as the shared r-bit length key K. The hash function randomly redistributes the n bits such that a small change in bits produces a large change in the hash value. Thus, even if Eve determines a number of bits of the transmitted key through eavesdropping, and also knows the hash function ƒ, she still will be left with very little knowledge regarding the content of the hashed r-bit key K. Alice and Bob may further authenticate the public channel transmissions to prevent a “man-in-the-middle” attack in which Eve masquerades as either Bob or Alice.

### SUMMARY OF THE INVENTION

In accordance with the purpose of the invention as embodied and broadly described herein, a method may include obtaining first encryption key material using quantum cryptographic mechanisms and obtaining second encryption key material using non-quantum cryptographic mechanisms. The method may further include encrypting data using the first encryption key material to produce first encrypted data and encrypting the first encrypted data using the second encryption key material to produce second encrypted data.

Consistent with a further aspect of the invention, a system may include a device configured to obtain first encryption key material using quantum cryptographic mechanisms. The system may further include a first encryptor configured to encrypt data using the first encryption key material to produce first encrypted data and a second encryptor configured to obtain second encryption key material using non-quantum cryptographic mechanisms and encrypt the first encrypted data using the second encryption key material to produce second encrypted data.

Consistent with another aspect of invention, a system may include a first encryptor configured to obtain first encryption key material using non-quantum cryptographic mechanisms and encrypt data using the first encryption key material to produce first encrypted data. The system may further include a device configured to obtain second encryption key material using quantum cryptographic mechanisms and a second encryptor configured to encrypt the first encrypted data using the second encryption key material to produce second encrypted data.

Consistent with yet another aspect of the invention, a method may include communicating a sequence of encryption key symbols between endpoints via a quantum channel using quantum cryptographic mechanisms and obtaining first encryption key material using non-quantum cryptographic mechanisms. The method may further include discussing the sequence of encryption key symbols via a non-quantum channel to obtain second encryption key material that comprises a subset of the sequence of encryption key symbols. The discussion is encrypted using the first encryption key material.

Consistent with an additional aspect of the invention, a method may include discussing, over a network, a sequence of symbols obtained using quantum cryptographic mechanisms to derive first encryption key material. The method may further include communicating traffic over the network based on the first encryption key material. The communicated traffic is cryptographically isolated from the discussion.

Consistent with a further aspect of the invention, a system may include a first encryptor configured to obtain first encryption key material using quantum cryptographic techniques. The system may further include a second encryptor configured to obtain second encryption key material using non-quantum cryptographic techniques. The data is encrypted using the first encryptor and second encryptor connected in series.

Consistent with yet another aspect of the invention, a system may include an encryptor and a device configured to derive encryption key material using quantum cryptographic techniques, and implement a key fill interface for injecting the encryption key material into the encryptor. The key fill interface includes one of a DS-101 or DS-102 key fill interface.

### BRIEF DESCRIPTION OF THE DRAWINGS

The accompanying drawings, which are incorporated in and constitute a part of this specification, illustrate one or more exemplary embodiments of the invention and, together with the description, explain the invention. In the drawings,

FIG. 1 illustrates existing cryptographic key distribution and ciphertext communication;

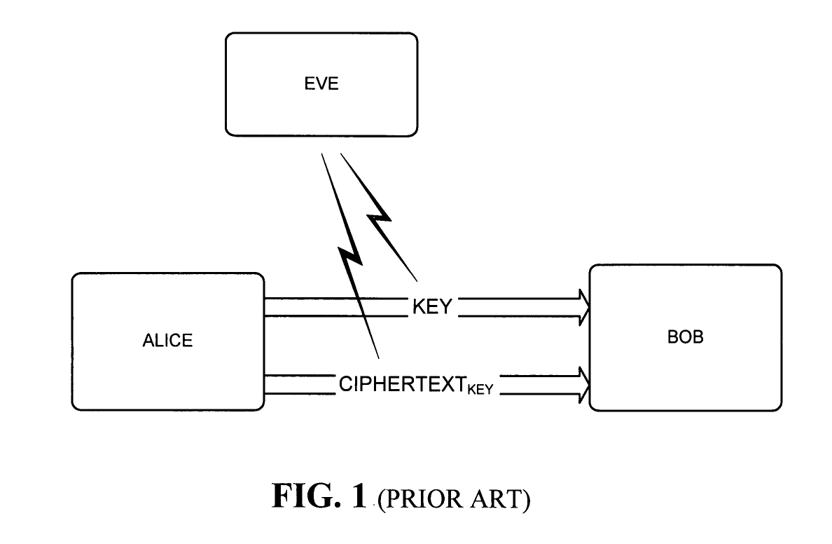

FIG. 2 illustrates an existing quantum cryptographic key distribution (QKD) process;

FIG. 3 illustrates an existing quantum cryptographic sifting and error correction process;

FIG. 4A illustrates an exemplary network implementation consistent with principles of invention;

FIG. 4B illustrates a further exemplary network implementation consistent with principles of the invention;

FIG. 4C illustrates an additional exemplary network implementation consistent with principles of the invention;

FIG. 5 illustrates an exemplary configuration of a QKD endpoint of FIGS. 4A, 4B and 4C consistent with the invention;

FIG. 6 illustrates exemplary components of the quantum cryptographic transceiver of FIG. 5 consistent with principles of the invention; and

FIG. 7 is a flow chart that illustrates an exemplary dual encryption process in a QKD system consistent with principles of the invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

As may be understood, there can be a natural reluctance on the part of communities who desire communications to embrace a novel form of cryptography, such as quantum cryptography, because there may be unforeseen flaws in the security of such novel techniques. In particular, users may be reluctant to adopt a quantum cryptographic system until there is a long, demonstrated track record of use without security issues. This leads to a “chicken and egg” problem in the adoption of quantum cryptography, in which the technology will not be employed until it has already demonstrated a long history of successful employment.

What is needed, therefore, is a way in which a quantum cryptographic system can be employed with assurances that the resultant security will be no worse than well-understood classical cryptographic systems. This invention provides such assurance, giving a resultant cryptographic system in which the security properties are at least as good as classical cryptographic systems, and which also offers the novel and heightened security associated with quantum cryptography.

Systems and methods consistent with principles of the invention, thus, provide this heightened security using quantum cryptography by implementing dual encryptors in series, where one of the encryptors uses encryption keys derived using quantum cryptography and a second of the encryptors uses encryption keys derived using “classical” key generation techniques (e.g., Diffie-Helman, shared secret keys distributed by a secure container, from a centralized facility, etc.). Traffic transmitted between a source and destination may, therefore, pass through two layers of encryption in series before it reaches a relatively unprotected transport network. Use of dual encryptors in series, consistent with principles of the invention, where one of the encryptors uses quantum cryptography, enables a high level of confidence that resultant transmitted traffic will really be cryptographically protected. These dual encryptors may be used in either order, e.g., performing classical encryption either before or after performing encryption with keys derived from quantum cryptography.

### Exemplary Network

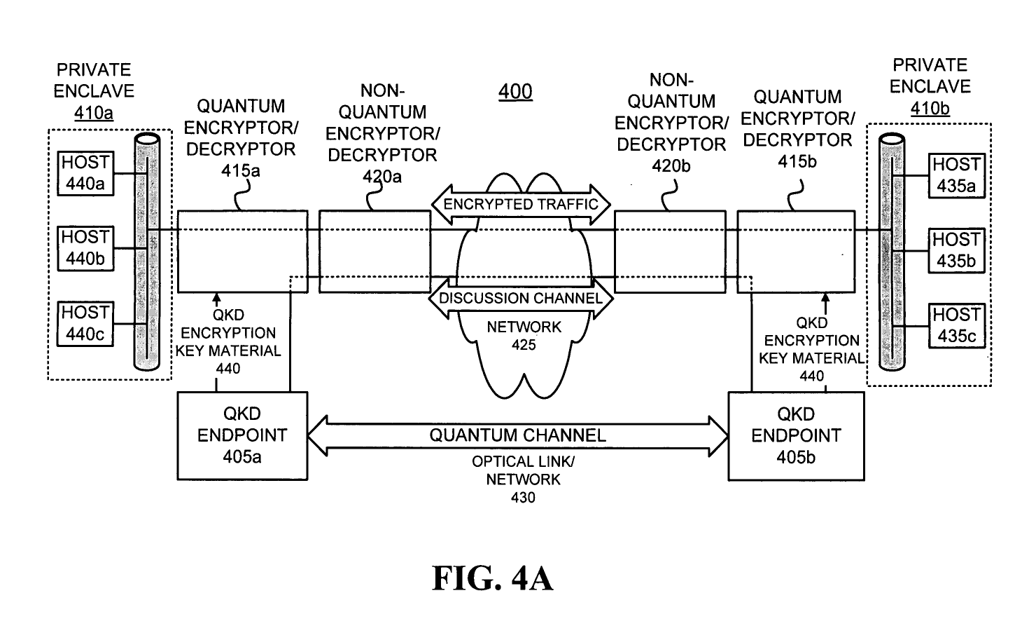

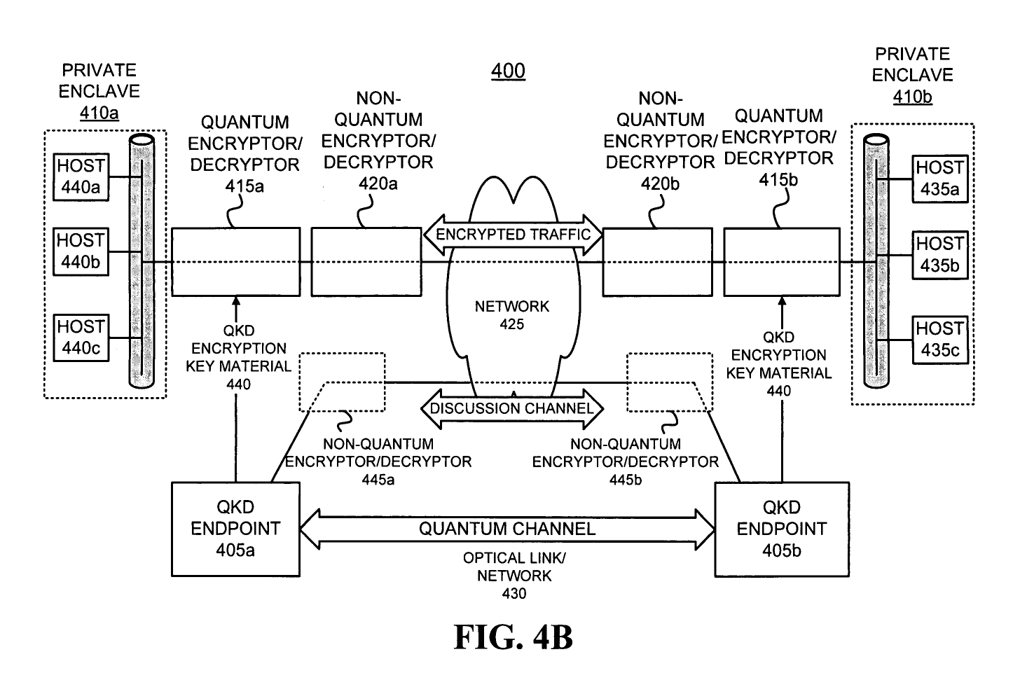

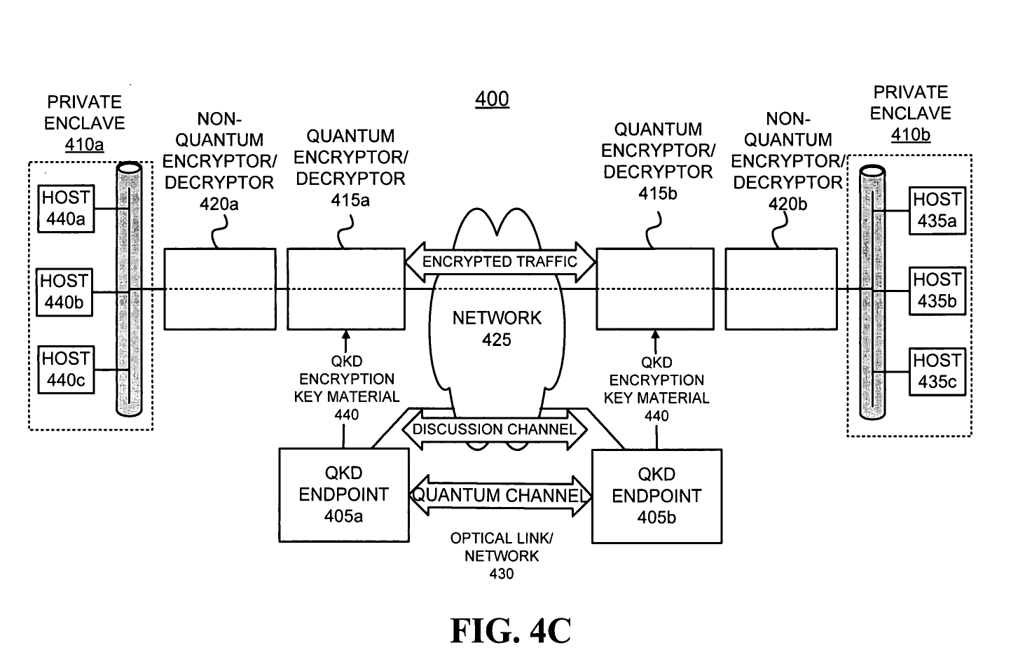

FIG. 4A illustrates an exemplary network implementation, consistent with principles of the invention, in which series encryption is applied using quantum cryptographic mechanisms. Network 400 may include QKD endpoints 405a and 405b, private enclaves 410a and 410b, quantum encryptors/decryptors 415a and 415b, and non-quantum encryptors/decryptors 420a and 420b. QKD endpoints 405a and 405b may be connected via network 425 and an optical link/network 430. Two QKD endpoints 405a and 405b have been shown for illustrative purposes only. Multiple QKD endpoints 405 (i.e., greater than two) may connect to one another via network 425 and via an optical link/network 430.

Private enclaves 410a and 410b may each include a local area network (LAN) interconnected with one or more hosts. FIG. 4A depicts hosts 435a-435c and 440a-440c for illustrative purposes only. Each private enclave 410 may include more, or fewer, hosts than those shown in FIG. 4A.

Network 425 may include one or more networks of any type, including a Public Land Mobile Network (PLMN), Public Switched Telephone Network (PSTN), LAN, metropolitan area network (MAN), wide area network (WAN), Internet, or Intranet. Network 425 may also include a dedicated fiber link or a dedicated freespace optical or radio link. The one or more PLMNs may further include packet-switched sub-networks, such as, for example, General Packet Radio Service (GPRS), Cellular Digital Packet Data (CDPD), and Mobile IP sub-networks.

Optical link/network 430 may include a link that may carry light throughout the electromagnetic spectrum, including light in the human visible spectrum and light beyond the human-visible spectrum, such as, for example, infrared or ultraviolet light. The link may include, for example, a conventional optical fiber. Alternatively, the link may include a free-space optical path, such as, for example, a path through the atmosphere or outer space, or even through water or other transparent media. As another alternative, the link may include a hollow optical fiber that may be lined with photonic band-gap material.

Furthermore, optical link/network 430 may include a QKD network that includes one or more QKD switches (not shown) for distributing encryption keys between a source QKD endpoint (e.g., QKD endpoint 405a) and a destination QKD endpoint (e.g., QKD endpoint 405b). Such a QKD network may include the QKD network described in U.S. patent application Ser. No. 09/943,709 (Attorney Docket No. 01-4015), entitled “Systems and Methods for Path Set-up in a Quantum Key Distribution Network,” and U.S. patent application Ser. No. 09/944,328 (Attorney Docket No. 00-4069), entitled “Quantum Cryptographic Key Distribution Networks with Untrusted Switches,” the entire disclosures of which are expressly incorporated by reference herein.

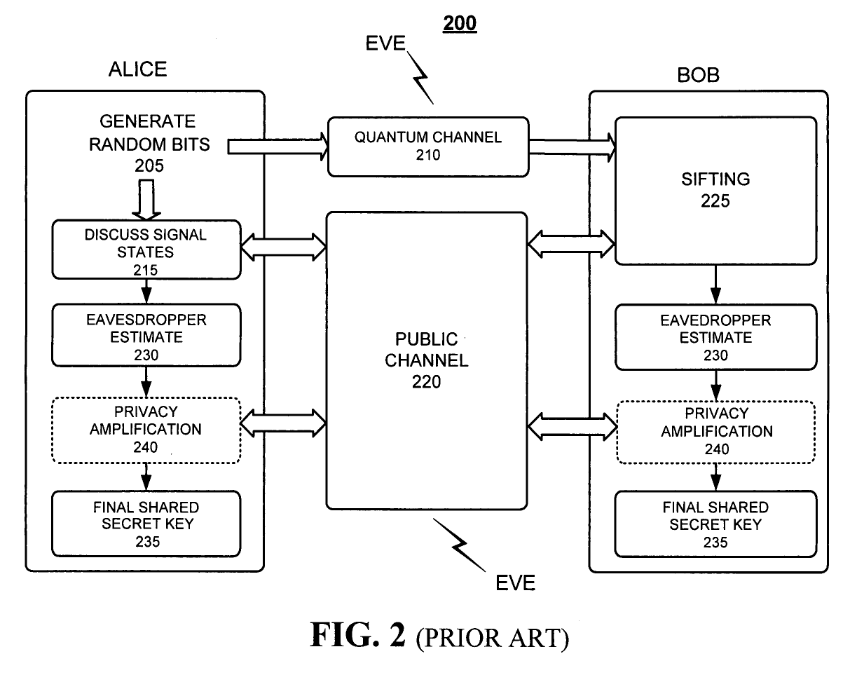

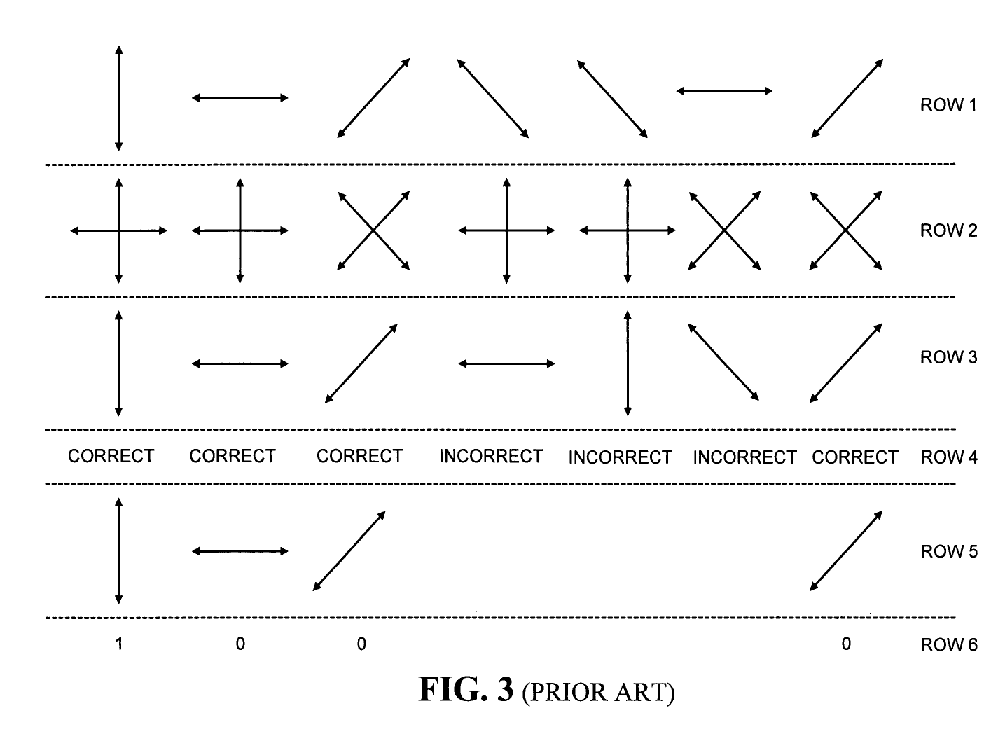

QKD endpoints 405a and 405b may distribute quantum cryptographic keys via a “quantum channel” of optical link/network 430. QKD endpoints 405a and 405b may distribute quantum cryptographic keys using any type of quantum cryptographic system including, for example, systems employing single-photon, or attenuated, optical pulses, “plug and play” systems, systems based on entanglement, or systems employing any form of quantum cryptography. Subsequent to quantum key distribution via the quantum channel of optical link/network 430, QKD endpoint 405a and QKD endpoint 405b may discuss distributed key material using a “discussion channel” of network 425 to agree on encryption key material 440 that may be provided to, and subsequently used by, quantum encryptors/decryptors 415a and 415b, for encrypting/decrypting traffic transported between private enclaves 410a and 410b via network 425. The “discussion” of the distributed key material may include existing techniques for deriving encryption key material from key symbols distributed via quantum cryptographic mechanisms, such as, for example, the techniques described above with respect to FIGS. 2 and 3 (e.g., sifting). The discussion channel may include a “public channel” across network 245 or an encrypted channel across network 245.

In the exemplary implementation shown in FIG. 4A, the discussion of the distributed key material via the discussion channel may also be encrypted/decrypted by quantum encryptors/decryptors 415a and 415b and non-quantum encryptors/decryptors 420a and 420b. Non-quantum encryptors/decryptors 420a and 420b may obtain cryptographic key material using “classical” techniques. Such “classical” techniques may include, for example, manual fill of cryptographic key material from secure containers, generation of session keys by Diffie-Helman or other algorithmic techniques, public key techniques, provisioning of keys from a central repository, etc. Other types of “classical” techniques for obtaining encryption key material may be used consistent with principles of the invention. Non-quantum encryptors/decryptors 420a and 420b may include any type of encryption/decryption device, including, for example, a High Assurance IP Encryptor (HAIPE) device.

After obtaining cryptographic key material using “classical” techniques, non-quantum encryptors/decryptors 420a and 420b may then encrypt/decrypt traffic, already encrypted/decrypted by quantum encryptors/decryptors 415a and 415b, for transport between private enclaves 410a and 410b. Non-quantum encryptors/decryptors 420a and 420b, thus, provide an additional level of encryption that does not use the QKD techniques employed by QKD endpoints 405a and 405b and quantum encryptors/decryptors 415a and 415b. Quantum encryptors/decryptors 415a and 415b and non-quantum encryptors/decryptors 420a and 420b may be implemented as stand alone devices (i.e., in separate devices from one another), as combined devices (i.e., combined in a single device), or as part of a respective QKD endpoint 405 (e.g., quantum encryptor/decryptor 415a and non-quantum encryptor/decryptor 420a implemented in QKD endpoint 405a).

FIG. 4B illustrates a further exemplary network implementation in which the discussion of the distributed key material via the discussion channel is encrypted/decrypted by non-quantum encryptors/decryptors 445a and 445b, and not encrypted/decrypted by either of quantum encryptors/decryptors 415a and 415b or non-quantum encryptors/decryptors 420a and 420b used to encrypt traffic between private enclaves 410a and 410b. Thus, in the exemplary network implementation of FIG. 4B, traffic between private enclaves 410a and 410b and discussion via the discussion channel are cryptographically isolated from one another (i.e., use different encryption key material and/or different encryption techniques). Discussion of the distributed key material occurs subsequent to quantum key distribution via the quantum channel of optical link/network 430 (as described above with respect to FIG. 4A).

FIG. 4C illustrates another exemplary network implementation in which traffic transported between private enclaves 410a and 410b is first encrypted by non-quantum encryptors/decryptors 420a and 420b prior to being encrypted by quantum encryptors/decryptors 415a and 415b. Also, as shown in FIG. 4C, the discussion of the distributed key material via the discussion channel may not be encrypted by either non-quantum encryptors/decryptors 420a and 420b or quantum encryptors/decryptors 415a and 415b. Thus, in this exemplary implementation, discussion between QKD endpoints 405a and 405b may occur publicly in the “open” on the discussion channel, without encryption being applied to the discussion traffic.

It will be appreciated that the number of components illustrated in FIGS. 4A, 4B and 4C is provided for explanatory purposes only. A typical network may include more or fewer components than are illustrated in FIGS. 4A, 4B and 4C.

### Exemplary QKD Endpoint

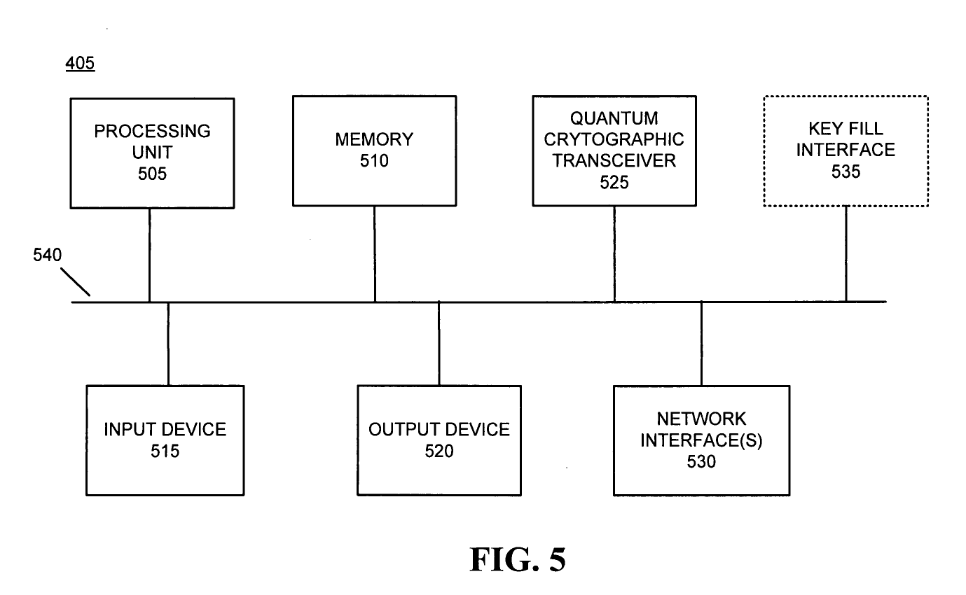

FIG. 5 illustrates exemplary components of a QKD endpoint 405, which can correspond to either QKD endpoint 405a or 405b, consistent with the invention. QKD endpoint 405 may include a processing unit 505, a memory 510, an input device 515, an output device 520, a quantum cryptographic transceiver 525, a network interface(s) 530, an optional key fill interface 535, and a bus 540. Processing unit 505 may perform all data processing functions for inputting, outputting, and processing of QKD endpoint data. Memory 510 may include Random Access Memory (RAM) that provides temporary working storage of data and instructions for use by processing unit 505 in performing processing functions. Memory 510 may additionally include Read Only Memory (ROM) that provides permanent or semi-permanent storage of data and instructions for use by processing unit 505. Memory 510 can also include large-capacity storage devices, such as a magnetic and/or optical recording medium and its corresponding drive.

Input device 515 permits entry of data into QKD endpoint 405 and may include a user interface (not shown). Output device 520 permits the output of data in video, audio, and/or hard copy format. Quantum cryptographic transceiver 525 may include mechanisms for transmitting and receiving encryption keys using quantum cryptographic techniques via a quantum channel of optical link/network 430. In some implementations, quantum cryptographic transceiver 525 may include the transceiver components described in U.S. application Ser. No. 10/985,631; entitled “Systems and Methods for Framing Quantum Cryptographic Links” and filed on Nov. 10, 2004, the disclosure of which is incorporated by reference herein in its entirety. Network interface(s) 530 may interconnect QKD endpoint 405 with network 425. Optional key fill interface 535 may include existing mechanisms for injecting cryptographic key material into a respective quantum encryptor/decryptor 415. In exemplary implementations, key fill interface 535 may include known interfaces such as DS-101 or DS-102 interfaces. Bus 540 interconnects the various components of QKD endpoint 405 to permit the components to communicate with one another.

### Exemplary Quantum Cryptographic Transceiver

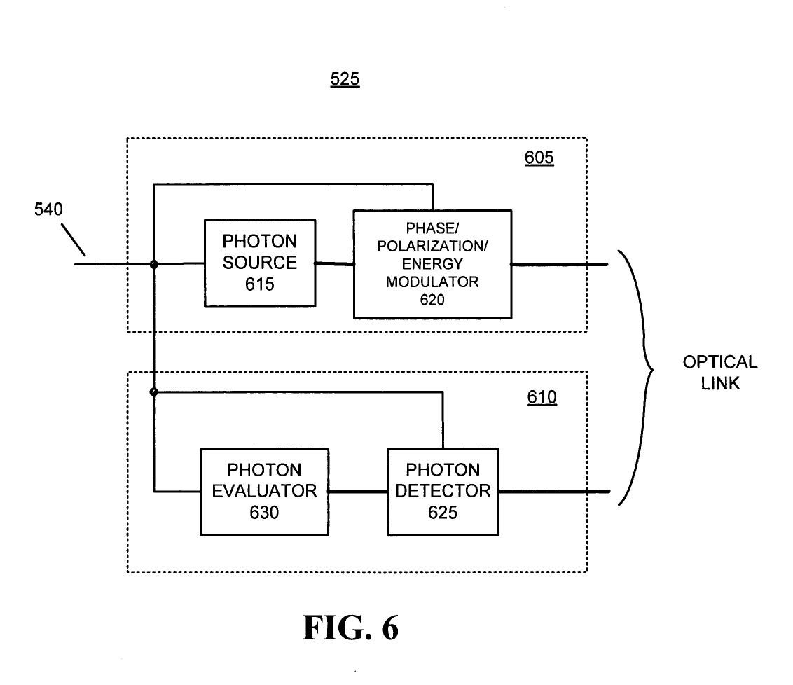

FIG. 6 illustrates exemplary components of quantum cryptographic transceiver 525 of a QKD endpoint 405 consistent with principles of the invention. Quantum cryptographic transceiver 525 may include a QKD transmitter 605 and a QKD receiver 610. QKD transmitter 605 may include a photon source 615 and a phase/polarization/energy modulator 620. Photon source 615 can include, for example, a conventional laser. Photon source 615 may produce photons according to instructions provided by processing unit 505. Photon source 615 may produce photons of light with wavelengths throughout the electromagnetic spectrum, including light in the human visible spectrum and light beyond the human-visible spectrum, such as, for example, infrared or ultraviolet light. Phase/polarization/energy modulator 620 can include, for example, Mach-Zehnder interferometers. Phase/polarization/energy modulator 620 may encode outgoing photons from the photon source according to commands received from processing unit 505 for transmission across an optical link or network, such as optical link/network 430.

QKD receiver 610 may include a photon detector 625 and a photon evaluator 630. Photon detector 625 can include, for example, one or more avalanche photo detectors (APDs) and/or photo-multiplier tubes (PMTs). Photon detector 625 may also include cryogenically cooled detectors that sense energy via changes in detector temperature or electrical resistivity as photons strike the detector apparatus. Photon detector 625 can detect photons received across optical link/network 430. Photon evaluator 630 may include circuitry for processing and evaluating output signals from photon detector 625 in accordance with quantum cryptographic techniques.

### Exemplary Series Encryption Process

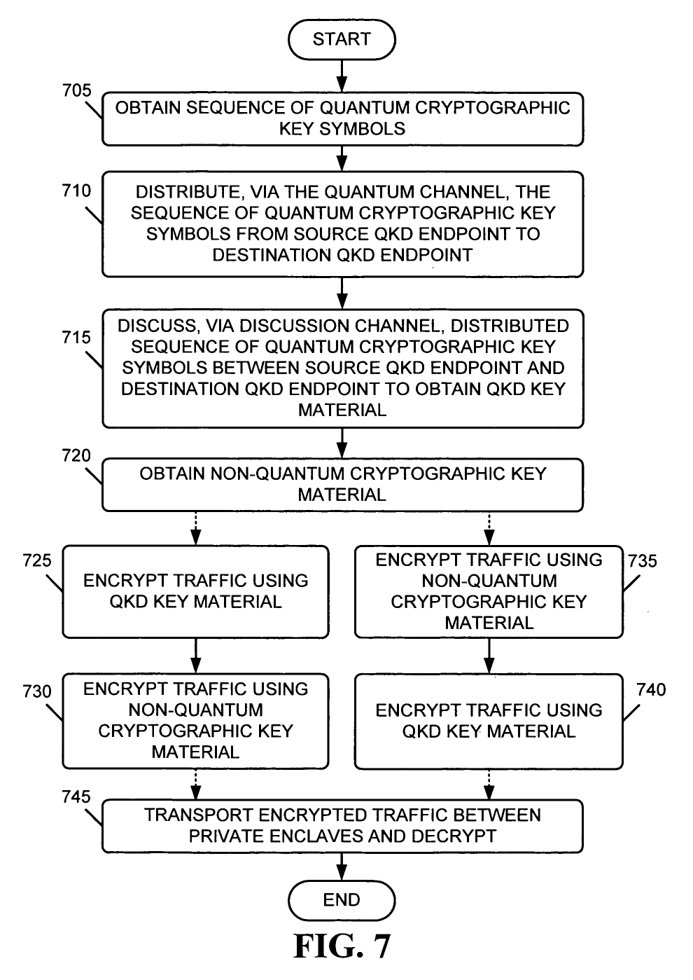

FIG. 7 is a flowchart that illustrates an exemplary process, consistent with principles of the invention, for providing series encryption of traffic transmitted between private enclaves 410a and 410b.

The exemplary process may begin by obtaining a sequence of quantum cryptographic key symbols (block 705). A QKD endpoint (e.g., QKD endpoint 405a) involved in QKD may obtain the quantum cryptographic key symbols using any existing technique for deriving encryption keys that can be used in any existing type of encryption/decryption technique. The obtained sequence of quantum cryptographic key symbols may then be distributed, via the quantum channel, from a source QKD endpoint to a destination QKD endpoint (block 710). For example, QKD endpoint 405a may distribute the cryptographic key symbols to QKD endpoint 405b via a quantum channel of optical link/network 430.

The source QKD endpoint and destination QKD endpoint may discuss, via a discussion channel, the distributed sequence of quantum cryptographic key symbols to obtain QKD key material (block 715). For example, QKD endpoint 405a may discuss, via a discussion channel of network 425, the sequence of quantum cryptographic key symbols distributed via the quantum channel with QKD endpoint 405b to obtain the QKD key material. In some implementations, the discussion may include employing “sifting” techniques to derive a subset of the sequence of quantum cryptographic key symbols distributed via the quantum channel to obtain the QKD key material. As shown in the exemplary network implementation of FIG. 4A, discussion via the discussion channel may be encrypted and decrypted by quantum encryptor/decryptors 415a and 415b and non-quantum encryptors/decryptors 420a and 420b. As further shown in the exemplary network implementation of FIG. 4B, public discussion via the discussion channel may be encrypted by non-quantum encryptor/decryptors 445a and 445b. As additionally shown in the exemplary network implementation of FIG. 4C, discussion via the discussion channel may not be encrypted at all and, thus, may be transmitted across the discussion channel in the “open” (e.g., a “public” channel).

Non-quantum cryptographic key material may be obtained by non-quantum encryptors/decryptors 420a and 420b. The non-quantum cryptographic key material may be obtained by non-quantum encryptors/decryptors 420a and 420b using “classical” techniques, such as, for example, manual fill of cryptographic key material from secure containers, generation of session keys by Diffie-Helman or other algorithmic techniques, public key techniques, provisioning of keys from a central repository, etc. Other types of “classical” techniques for obtaining encryption key material may be used consistent with principles of the invention.

In the exemplary network implementation shown in FIG. 4A, traffic sent between private enclave 410a and 410b may first be encrypted by quantum encryptor/decryptor 415a using the QKD key material derived using QKD and discussion (block 725). After encryption by encryptor/decryptor 415a, the encrypted traffic may then be encrypted again by non-quantum encryptor/decryptor 420a using the obtained non-quantum cryptographic key material (block 730). The series encrypted traffic may be transported between private enclaves 410a and 410b via network 425 (block 745), decrypted by non-quantum encryptor/decryptor 420b using the obtained non-quantum cryptographic key material and then further decrypted by quantum encryptor/decryptor 415b using the QKD key material derived using QKD and discussion.

In the exemplary network implementation shown in FIG. 4C, traffic sent between private enclaves 410a and 410b may first be encrypted by non-quantum encryptor/decryptor 420a using the obtained non-quantum cryptographic key material (block 735). After encryption by non-quantum encryptor/decryptor 420a, the encrypted traffic may then be encrypted again by quantum encryptor/decryptor 415a using the QKD key material derived using QKD and discussion (block 740). The series encrypted traffic may be transported between private enclaves 410a and 410b via network 425 (block 745), decrypted by quantum encryptor/decryptor 415b using the obtained the QKD key material derived using QKD and discussion, and then further decrypted by non-quantum encryptor/decryptor 420b using the obtained non-quantum cryptographic key material.

### CONCLUSION

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in software and others in hardware, other configurations may be possible.

While a series of acts has been described with regard to FIG. 7, the order of the acts may vary in other implementations consistent with the present invention. Also, non-dependent acts may be performed in parallel. No element, act, or instruction used in the description of the present application should be construed as critical or essential to the invention unless explicitly described as such. Also, as used herein, the article “a” is intended to include one or more items. Where only one item is intended, the term “one” or similar language is used. The scope of the invention is defined by the following claims and their equivalents.

What is claimed is:

1. A method, comprising:
obtaining first encryption key material using quantum cryptographic mechanisms;
obtaining second encryption key material using non-quantum cryptographic mechanisms;
encrypting data using the first encryption key material to produce first encrypted data; and
encrypting the first encrypted data using the second encryption key material to produce second encrypted data.

2. The method of claim 1, wherein obtaining the second encryption key material using non-quantum cryptographic mechanisms comprises at least one of:
generating the second encryption key material using algorithmic techniques, obtaining the second encryption key material using public key techniques, obtaining the second encryption key material via provisioning of key material from a central repository, or manual fill of the second encryption key material from secure containers.

3. The method of claim 1, wherein obtaining the first encryption key material using quantum cryptographic mechanisms comprises:
communicating a sequence of encryption key symbols between quantum cryptographic endpoints using quantum cryptographic techniques; and
conducting a discussion of the sequence of encryption key symbols between the quantum cryptographic endpoints to obtain a subset of the sequence of encryption key symbols as the first encryption key material.

4. A system, comprising:
a device configured to obtain first encryption key material using quantum cryptographic mechanisms;
a first encryptor configured to encrypt data using the first encryption key material to produce first encrypted data;
a second encryptor configured to:
obtain second encryption key material using non-quantum cryptographic mechanisms, and
encrypt the first encrypted data using the second encryption key material to produce second encrypted data.

5. A system, comprising:
a first encryptor configured to:
obtain first encryption key material using non-quantum cryptographic mechanisms, and
encrypt data using the first encryption key material to produce first encrypted data; and
a device configured to obtain second encryption key material using quantum cryptographic mechanisms; and
a second encryptor configured to encrypt the first encrypted data using the second encryption key material to produce second encrypted data.

6. A method, comprising:
obtaining first encryption key material using non-quantum cryptographic mechanisms;
obtaining second encryption key material using quantum cryptographic mechanisms;
encrypting data using the first encryption key material to produce first encrypted data; and
encrypting the first encrypted data using the second encryption key material to produce second encrypted data.

7. A method, comprising:
communicating a sequence of encryption key symbols between endpoints via a quantum channel using quantum cryptographic mechanisms;
obtaining first encryption key material using non-quantum cryptographic mechanisms; and
discussing the sequence of encryption key symbols via a non-quantum channel to obtain second encryption key material that comprises a subset of the sequence of encryption key symbols, wherein the discussion is encrypted using the first encryption key material.

8. The method of claim 7, further comprising:
using the second encryption key material for encrypting data traffic sent between a source and destination.

9. The method of claim 7, wherein obtaining the first encryption key material using non-quantum cryptographic mechanisms comprises at least one of:
generating the first encryption key material using algorithmic techniques, obtaining the first encryption key material using public key techniques, obtaining the first encryption key material via provisioning of key material from a central repository, or obtaining the first encryption key material via manual fill of the second encryption key material from secure containers.

10. A system, comprising:
an encryptor configured to obtain first encryption key material using non-quantum cryptographic mechanisms;
a first quantum cryptographic key distributor configured to:
communicate a sequence of encryption key symbols to or from a second quantum cryptographic key distributor using quantum cryptographic mechanisms via a quantum channel, and
discuss the sequence of encryption key symbols with the second quantum cryptographic key distributor via a non-quantum channel to obtain second encryption key material that comprises a subset of the sequence of encryption key symbols,
wherein the encryptor is further configured to encrypt the discussion using the first encryption key material.

11. A method, comprising:
discussing, over a network, a sequence of symbols obtained using quantum cryptographic mechanisms to derive first encryption key material; and
communicating traffic over the network based on the first encryption key material, wherein the communicated traffic is cryptographically isolated from the discussion.

12. The method of claim 11, wherein cryptographically isolating the traffic from the discussion comprises:
using different encryption key material than the first encryption key material to encrypt the discussion.

13. The method of claim 11, wherein cryptographically isolating the traffic from the discussion comprises:
using a different encryption technique to encrypt the discussion and the communicated traffic.

14. A system, comprising:
a first encryptor configured to obtain first encryption key material using quantum cryptographic techniques; and
a second encryptor configured to obtain second encryption key material using non-quantum cryptographic techniques,
wherein data is encrypted using the first encryptor and second encryptor connected in series.

15. The system of claim 14, wherein the first encryptor encrypts the traffic prior to encryption by the second encryptor.

16. The system of claim 14, wherein the second encryptor encrypts traffic prior to encryption by the first encryptor.

17. The system of claim 14, wherein the data comprises communication traffic transmitted between a source and destination.

18. A system, comprising:
an encryptor;
a device configured to:
derive encryption key material using quantum cryptographic techniques, and
implement a key fill interface for injecting the encryption key material into the encryptor, wherein the key fill interface includes one of a DS-101 or DS-102 key fill interface.

19. A system, comprising:
means for obtaining first encryption key material using quantum cryptographic mechanisms;
means for obtaining second encryption key material using non-quantum cryptographic mechanisms;
means for encrypting data using the first encryption key material to produce first encrypted data; and
means for encrypting the first encrypted data using the second encryption key material to produce second encrypted data.
